(19) United States
(12) Patent Application Publication
(10) Pub. No.: US 2020/0078922 A1
(43) Pub. Date: Mar. 12, 2020

(54) DUST CLEANING DEVICE FOR POWER TOOLS COOLING AIR CLEANING

(71) Applicant: Janez Petrovic, Golnik (SI)

(72) Inventor: Janez Petrovic, Golnik (SI)

(21) Appl. No.: 16/612,746

(22) PCT Filed: May 12, 2017
(86) PCT No.: PCT/SI2017/000010

§ 371 Date: Nov. 11, 2019

(51) Int. Cl. B25F 5/00; B24B 23/02

(52) U.S. Cl. CPC B25F 5/008; B24B 23/04; B24B 23/028

(57) ABSTRACT

The present invention belongs to the field of working processes and transport, more precisely to the field of devices for cooling the drive motor of electric hand-held power tools. A separator (1) of the device for removing dust particles from the cooling air for electric hand-held power tools according to the invention is designed in the shape of a cylinder or preferably as a truncated hollow cone with a bottom ring (11) and an upper ring (12) with a circular surface (121) with a hub (122). The separator has on the circumference in of the cone one or more, preferably nine uniformly distributed ribs (13) rotated for an angle a with regards to the transverse axis of the cone. Each rib (13) has a surface (131), which due to its position enables bouncing off larger dust particles, when a working drive motor (2) spins a fan (3) for cooling the motor (2) and creates suction of outer air through the separator (1) in a handle (42). The cooling air enters the housing (4) through entry slots (421) of the handle (42) and openings (14) of the separator (1), while it leaves through outlet openings (431) of a reducer part (43), which closes the housing (4). Because the larger dust particles are removed before entering the tool, only cooling air with smaller dust particles enters the interior of the electric tool.

The present invention belongs to the field of working processes and transport, more precisely to the field of devices for cooling the drive motor of electric hand-held power tools.

The technical problem, which is solved by the present invention, is a constructional design of a device for removing dust from cooling air, which could be installed in electric hand-held tools and would enable efficient removal of dust particles from the environment, which together with the cold air enter into the interior of electric tools. Electric power tools, such as drills and sanders, cause formation of dust particles, which whirl together with air is that is sucked by the tool from its environment. The dust particles, which enter the tool interior cause damage, especially on rotating parts and consequently affect the length of tool life. Therefore, the device should be constructed in such a way that its manufacturing process is relatively easy and that it uses only a small amount of power, so that the majority of the power can be used for powering the electric power tool.

During use of electric hand-held power tools, particularly of tools intended for processing of different building materials and metals, such as angle grinders, concrete sanders, wall cutters and similar, a large amount of dust is created. These dust particles can be relatively large in case of concrete sanders or sanders for metal materials, which have aggressive abrasives. A part of generated dust particles enters into the electric hand-held tool together with the cooling air. An optimal flow of the cooling air, which cools the drive motor of electric hand-held power tool, is enabled by a fan installed on a rotary shaft of the drive electromotor. The cooling air that enters through the entry slots, and then flows between the housing of the tool and stator of the electromotor as well as between the stator and the rotor, thereby cooling the stator as well as the rotor of the drive motor so that they do not heat above the allowed temperature. Both rotor and stator coils of the electromotor are in the air flow. The dust particles in the cooling air consequently hit both coils, which leads to thinning of the insulation layer on the coils that can cause damage of this layer. The coincidence of this is that the coils may be damaged, a short circuit can be created and/or the drive electromotor of the tool may be destroyed. In order to prevent this, the wires of the coils are typically additionally protected with a layer of special insulation material. In case of large amount of dust particles also this special additional layer may be damaged and consequently the electromotor as well. In particular larger particles cause extensive damage of the insulation layer, because they have high energy due to high movement speed. Moreover, a part of the dust particles is deposited in the interior of the tool, which can consequently lead to short circuits between the non-insulated electrical parts or guides of carbon brushes and conductor contacts.

European patent 2 527 099 B1 discloses an electric tool having an electromotor, an assembly for creating flow of cooling air and an assembly for removing dust from the cooling air. The assembly for creating cooling air flow comprises a fan, which is driven by the electromotor and which during use of the tool generates a flow of cooling air through the electric tool. The assembly for removing dust from the cooling air comprises a passive fan, which is not driven by the drive motor, but the flow of the cooling air. It is mounted on the shaft of the electromotor and when working directs the air into rotation movement, wherein the dust particles are faced with mechanical barriers and especially centrifugal force that is large enough to eliminate dust particles from the cooling air flowing through the assembly for removing dust from cooling air. This solution differs from the present invention in that the present invention is more simple than the disclosed device for de-dusting cooling air, which quite efficiently removes dust particles from the cooling air, but is difficult to manufacture, takes a lot of space in the longitudinal directions, which consequently increases the dimensions of the electric hand-held tool and also the weight of the tool. For its operation the device consumes a relatively large amount of power, so that there is less available power for the basic operation of the electric hand tools.

The device for removing dust from cooling air for electric hand-held tools according to the invention comprises a separator 1, which is through a hub 122 mounted on a shaft 21 of a drive electromotor 2 between a bearing 211 and a handle 42 of an angle grinder 5. On the other side of the shaft 21 is a bearing 212, besides which a fan 3 is installed. In order to create a flow of cooling air through the drive electromotor 2, the air for cooling enters into a housing 4 of the tool through entry slots 421 of the handle 42 and through openings 14 along surfaces 131 of ribs 13 on the separator 1, while the air leaves through outlet openings 431 in a reducer part 43 of the housing 4 of the grinder 5.

An embodiment of the device for removing dust from cooling air for electric hand-held tools according to the invention will be described in further detail based on figures, which show:

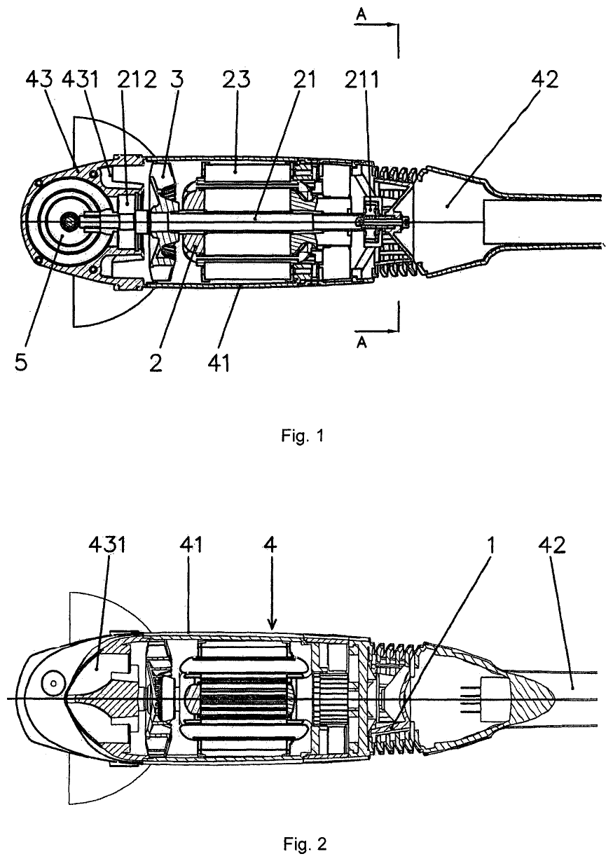

FIG. 1 a partial longitudinal cross-section through an angle grinder or a concrete grinder with the device according to the invention

FIG. 2 a partial longitudinal cross-section through an angle grinder or a concrete grinder with the device according to the invention

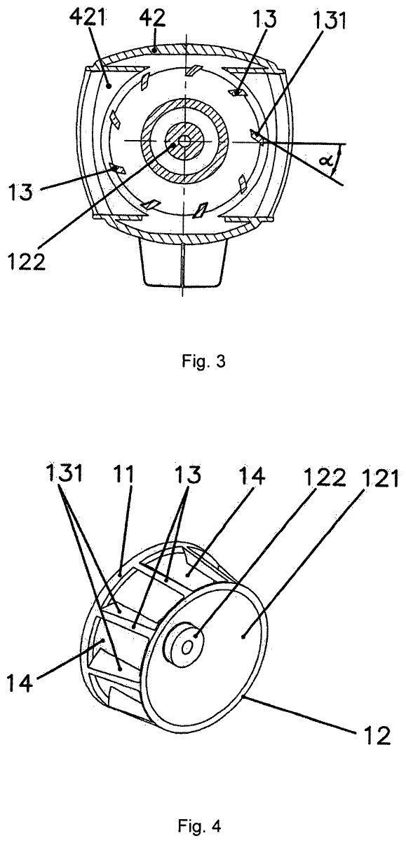

FIG. 3 a cross-section A-A from FIG. 1

FIG. 4 an embodiment of the dust separator

The device for removing dust from cooling air for electric hand-held tools comprises a tri-part housing 4, having a drive electromotor 2 with a fan 3 located in a part 41, a reducer part 43 on the side of an angle grinder 5 and a main handle 42 with a separator 1 on the other side.

The separator 1 of the device for removing dust particles from cooling air for electric hand-held power tools according to the invention is preferably designed as a cylinder or more preferably as a truncated hollow cone, having a bottom ring 11 and an upper ring 12 with a cone-shaped surface 121 with the hub 122. The surface 121, which connects the hub and the ring 12 can be simplified, so that it is shaped as a flat circular plate. The separator has on the circumference of the cone one or more, preferably nine, uniformly distributed ribs 12, which are rotated for an angle a with regards to the transverse axis of the cone. Each rib 13 has a surface 131, which enables bouncing off larger dust particles, when the working drive motor 2 spins the fan 3 for cooling the motor 2 and created suction of cooling air through the separator 1 in the handle 42. The cooling air enters the housing 4 through entry slots 421 of the handle 42 and openings 14 of the separator 1, while it leaves through outlet openings 431 on the reducer part 43 of the housing 4. Because the larger dust particles are removed by the separator 1, only smaller dust particles may enter with the cooling air into the interior of the electric tool.

The separator 1 can be designed in such a way that the diameters of the rings 11 and 12 are equal and that it may have on its circumference one or more, preferably nine, uniformly distributed ribs 13.

The separator 1 of the device for removing dust particles from the cooling air for electric hand-held power tools has between the bottom ring 11 and the upper ring 12 one or more, preferably nine ribs 13, between which openings 14 are located. The upper part of the separator 1 has the cone surface 121 inside the ring 12, wherein the hub 122 is placed in the middle of the surface 121. The separator 1 can have on the circumference of the cone between 5 and 15 uniformly distributed ribs 13 rotated for angle a with regards to the transverse axis of the cone, which depends on the rotation speed of the motor and on the side or power of the electric hand-held tool. Each rib has an approximately rectangular cross-section and has in radial direction a relatively narrow surface 131. The ribs 13 are situated along the entire length of entry openings 14, and are uniformly distributed on the circumference of rings 11 and 12 in the direction of rotation. The surface 131 of the ribs 13 due to its position enables bouncing off large dust particles, when the working drive motor 2 spins the fan 3 and creates suction of outer air through openings 14 of the separator 1 and slots 421 of the handle 42. The cooling air enters into the housing 4 through entry slots 421 of the handle 42 and through openings 14 of the separator 1, while it leaves through outlet openings 431 on the reducer part 43 of the housing 4. The separator 1 installed in the handle 42 is via the hub 122 rigidly connected with the shaft 21 so that it rotates together with it. Because the large dust particles are eliminated before they enter the interior of the electric hand-held power tool, only dust with smaller particles enters with the air for cooling the motor 2.

The dimension of the ribs 13 with surface 131 in the radial direction and the is number of ribs depend on the size of the electric hand-held power tool and its power as well as speed of air that is needed for optimal cooling of the drive motor. The device can have one or more ribs 13, preferably 5 to 15. It is required that dust particles in the air, which enters the space between neighbouring ribs 13, hit onto the surfaces 131 and due to relatively high circumferential speed of the separator 1 bounce off back into the space. It is possible to achieve that the dust particles bounce off the surface 131 and return to the space through openings 421 with a suitable selection of the angle a. Size of the angle a mostly depends on the shape of the entry slots 421, which also depends on the shape of the handle 42, rotation speed of the motor and power and shape of the drive electromotor 2. The optimal angle a has values approximately between 0° to 60°. During work with hand-held tools a situation may occur, in which the dust particles do not enter through the openings and bounce back to the space, but a part of them enters the housing 4 in another way.

Opposite to the ribs 13 of the separator 1 the main handle 42 is equipped with entry slots 421 in the shape of elongated slots, of which side surfaces are approximately perpendicular to the axis 21 of the motor 2.

With the separator 1, which is installed into the handle of the electric hand-held power tool, the majority of the dust particles are bounced away from the ribs 13, thereby protecting the interior of the electric tool, in particularly the coils of the rotor 22 and the stator 23, from erosion cause by dust particles.

The proposed solution of the device for removing dust particles from cooling air for electric hand-held power tools enables good filtration of larger dust particles from air, which enters into the interior of tools, wherein the device is simple to manufacture, occupies a small space and represents only a minimal increase of the whole tool weight. In addition, the device uses a very small amount of power for its functioning because it exploits the rotary motion of the drive motor. Furthermore, the solution of the device for removing dust particles removes or bounces away the dust particles from cooling air is immediately after they enter the tool handle, whereby the dust particles leave the tool through entry slots and return to the space. In this manner the dust particles, created by the tool during its use, do not enter deeply into the interior of the electric tool.

What is claimed is:

1. An electric hand-held tool comprising a separator (1) for removing dust particles from cooling air, wherein
the tool comprises a tri-part housing (4), having a drive electromotor (2) with a fan (3) located in a part (41), a reducer part (43) and on the other side a main handle (42) with entry slots (421) for suction of cooling air,
characterized in that wherein
the separator (1) is shaped as a cylinder or preferably as a truncated hollow cone with a bottom ring (11) and an upper ring (12) with a surface (121), preferably cone shaped, having a hub (122):
the separator (1) is through the hub (122) mounted on a shaft (21) of the drive electromotor (2) between a bearing (211) and the handle (42) 15 of the tool (5), so that rigid connection with the shaft is enabled and the separator can rotate together with the shaft (21);
the separator (1) has on the circumference of the ring (11) and ring (12) along the entire length of entry openings (14) a plurality of uniformly distributed ribs (13) rotated for an angle a with regards to the transverse axis of the cone;
each rib (13) has an approximately rectangular cross-section and has in a radial direction a relatively narrow surface (131), from which larger dust particles bounce off due to circumferential speed of the separator (1) through entry slots (421) of the handle (42),
that due to such construction larger particles in the cooling air bounce out of the handle (42), which results in removal of larger dust particles before they enter into the electric hand-held tool, while the remaining cooling air passes through openings (14) of the separator (1).

2. The electric hand-held tool comprising a separator (1) for removing dust particles from cooling air according to claim 1, wherein the angle a is between 0° and 60°.

3. The electric hand-held tool comprising a separator (1) for removing dust particles from cooling air according to claim 1, wherein it has five to fifteen uniformly distributed ribs (13).

4. The electric hand-held tool comprising a separator (1) for removing dust particles from cooling air according to claim 1, wherein the surface (121), which connects the hub (122) and the upper ring (12), is a flat circular plate.

5. The electric hand-held tool comprising a separator (1) for removing dust particles from cooling air according to claim 1, wherein the diameters of the rings (11 and 12) are equal.

6. The electric hand-held tool comprising the separator (1) according to claim 1, wherein the cooling air enters the housing (4) through entry slots (421) of the handle (42) and openings (14) of the separator (1), whereby larger particles are removed by bouncing off the surfaces (131) of ribs (13), while the cooling air leaves through outlet openings (431) on the reducer part (43) of the housing (4).

7. The electric hand-held tool according to claim 1, wherein opposite to the ribs (13) of the separator (1) on the main handle (42) the device has entry slots (421) in the shape of elongated slots, of which side surfaces are approximately perpendicular 25 to the axis (21) of the motor (2).

8. The electric hand-held tool according to claim 1, wherein the tool is an angle grinder.

9. A hand-held tool comprising:
a separator (1) for removing dust particles from an air sample, and
a tri-part housing (4), comprising
a drive electromotor (2) comprising a fan (3) located in a part (41);
a reducer part (43); and
a handle (42) with entry slots (421) for suction of the air sample.

10. The tool of claim 9, wherein the separator (1) comprises a cylindrical or hollow cone shape;
a transverse axis;
a bottom ring (11);
an upper ring (12);
a plurality of entry openings (14); and
a plurality of ribs (13) disposed along the bottom ring (11) and rotated at an angle a with respect to the transverse axis.

11. The tool of claim 10, wherein each rib of the plurality of ribs (13) comprises a rectangular cross-section.
